(19) United States
(12) Patent Application Publication
(10) Pub. No.: US 2026/0261762 A1
(43) Pub. Date: Sep. 3, 2026

(54) APPARATUS THAT SUPPORTS SUPPORTED OBJECT, CONTROL METHOD FOR THE APPARATUS, AND STORAGE MEDIUM

(71) Applicant: CANON KABUSHIKI KAISHA, Tokyo (JP)

(72) Inventor: RYOTA OGAWA, Kanagawa (JP)

(21) Appl. No.: 19/543,153

(22) Filed: Feb. 18, 2026

(30) Foreign Application Priority Data
Feb. 28, 2025 (JP) 2025-030862

(51) Int. Cl. H04N 23/68; G01P 21/00; G03B 17/56; G08B 21/18

(52) U.S. Cl. CPC H04N 23/6812; G01P 21/00; G03B 17/561; G08B 21/182

(57) ABSTRACT

An apparatus controls a support unit using a control method selected from a plurality of control methods. The plurality of control methods include, as an angular velocity using method for controlling the support unit using the angular velocity around a specific axis among the plurality of axes and correction data on an offset value of the angular velocity sensor according to the temperature, a first method in which the specific axis is a first axis, and a second method in which the specific axis is different from the first axis. One or more processors operate to issue a notification that prompts calibration to update the correction data in a case where the temperature is within a predetermined range, and change the predetermined range according to whether the first method or the second method is selected.

### BACKGROUND

### Field of the Technology

The present disclosure relates to an apparatus having a support mechanism, such as a gimbal, a control method for the apparatus, and a storage medium.

### Description of the Related Art

In an apparatus equipped with a gimbal used to suppress shake of a handheld supported object, the driving of the gimbal is controlled so that an angular velocity detected by an angular velocity sensor approaches zero. However, the output of the angular velocity sensor contains an offset value, which changes with temperature. Thus, the gimbal can be operated properly by calibration to update the offset value before the gimbal is operated.

Japanese Patent Application Laid-Open No. 2006-98200 discloses an apparatus that determines whether or not to perform calibration and notifies the user in a case where calibration is necessary, in order to reduce the frequency of calibration.

### SUMMARY

An apparatus according to one aspect of the present disclosure may include a supported object, a support unit configured to rotate the supported object around a plurality of axes, an angular velocity sensor configured to detect an angular velocity of the supported object around the plurality of axes, a temperature sensor configured to detect a temperature of the angular velocity sensor, one or more memories storing instructions, and one or more processors that, upon execution of the instructions, operate to control the support unit using a control method selected from a plurality of control methods. The plurality of control methods may include, as an angular velocity using method for controlling the support unit using the angular velocity around a specific axis among the plurality of axes and correction data on an offset value of the angular velocity sensor according to the temperature, a first method in which the specific axis is a first axis, and a second method in which the specific axis is different from the first axis. The one or more processors may operate to issue a notification that prompts calibration to update the correction data in a case where the temperature is within a predetermined range, and change the predetermined range according to whether the first method or the second method is selected. Alternatively, the plurality of control methods may include an angular velocity using method for controlling the support unit using the angular velocity and correction data on an offset value of the angular velocity sensor according to the temperature, and an angular velocity non-using method for controlling the support unit without using the angular velocity. The one or more processors may operate not to issue a notification that prompts calibration to update the correction data in a case where the angular velocity non-using method is selected, and operate to issue a notification that prompts the calibration in a case where the angular velocity using method is selected and the temperature is within a predetermined range. A control method corresponding to the above apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views of an image pickup apparatus according to this embodiment.

FIG. 2 is a block diagram illustrating the optical and electrical configuration of the image pickup apparatus according to this embodiment.

FIG. 3 illustrates the control configuration of the image pickup apparatus according to this embodiment.

FIG. 4 is a flowchart illustrating the processing performed by the image pickup apparatus according to this embodiment.

FIGS. 5A, 5B, and 5C illustrate angular velocity-temperature correction tables in this embodiment.

FIG. 6 illustrates a relationship between a gimbal mode and an angular velocity offset in this embodiment.

FIG. 7 is a flowchart illustrating the processing in this embodiment.

FIG. 8 is a diagram in which a determination temperature range has been added to the angular velocity-temperature correction table in this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure.

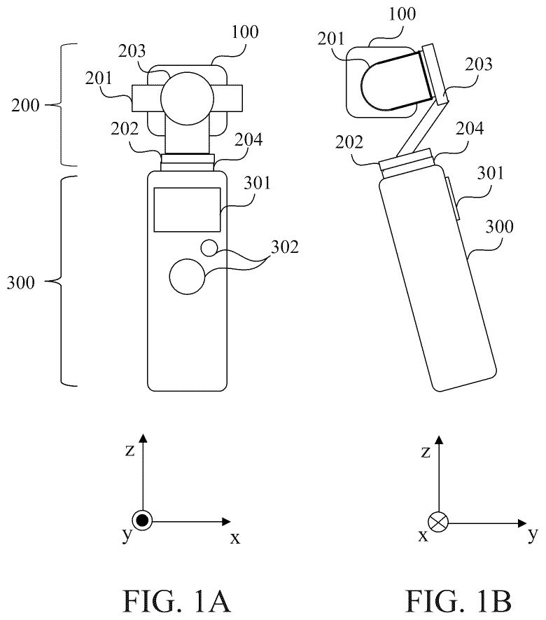

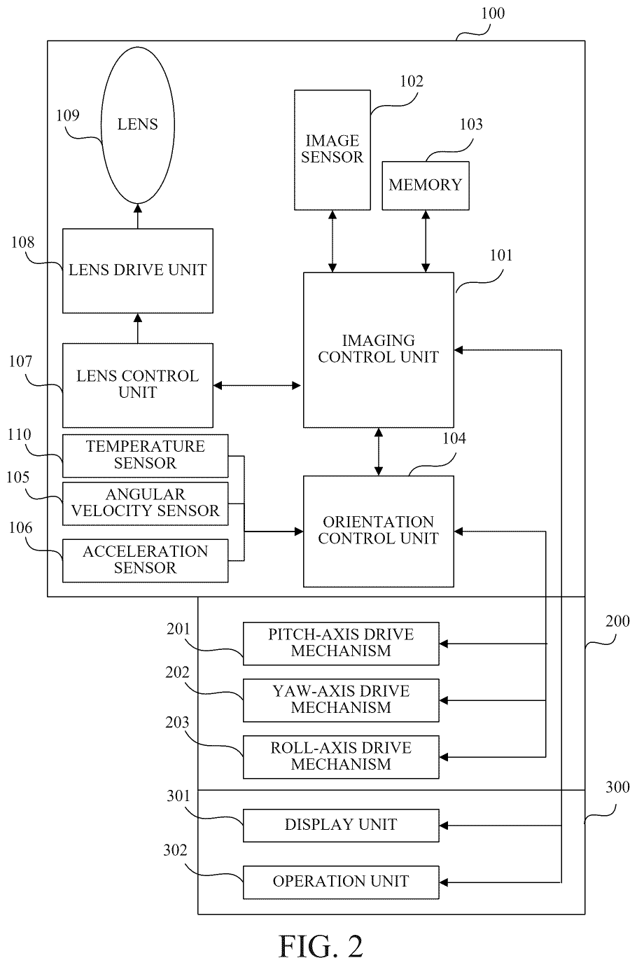

FIGS. 1A and 1B illustrate the appearance of an image pickup apparatus (gimbal camera) according to this embodiment, viewed from y and x directions. FIG. 2 illustrates the optical and electrical configuration of the image pickup apparatus. The image pickup apparatus has an imaging unit 100 as a supported object, a gimbal 200 as a support unit (support mechanism), and a grip portion 300.

The imaging unit 100 includes an imaging lens 109, and an image sensor 102 including a photoelectric conversion element such as a CCD sensor or CMOS sensor. The image sensor 102 photoelectrically converts (captures) an optical image formed by the imaging lens 109. The imaging unit 100 further includes an imaging control unit 101, a memory 103, a lens control unit 107, and a lens drive unit 108.

The imaging control unit 101 controls imaging according to an operation signal from an operation unit 302 provided in the grip portion 300. The imaging control unit 101 also generates image data from an electrical signal output from the image sensor 102 and stores the image data in the memory 103, which may include RAM, ROM, flash memory, etc.

The lens control unit 107 drives the actuator in the lens drive unit 108 according to a command from the imaging control unit 101, causing the imaging lens 109 to perform zoom and focus operations.

The imaging unit 100 further includes an orientation control unit 104, an angular velocity sensor 105, an acceleration sensor 106, and a temperature sensor 110.

The angular velocity sensor 105 is a gyro sensor that detects angular velocity around three axes of the imaging unit 100: the yaw axis (a first axis extending in the z direction in FIG. 1A), the pitch axis (an axis extending in the x direction), and the roll axis (an axis extending in the y direction). The acceleration sensor 106 detects acceleration around three axes of the imaging unit 100: the yaw axis, pitch axis, and roll axis.

The temperature sensor 110 detects the temperature of the angular velocity sensor 105. The temperature detected by the temperature sensor 110 is used to determine whether or not calibration of the angular velocity-temperature correction table, which will be described later, is necessary. This will be described later.

In a case where the gimbal 200 supports the imaging unit 100 about two axes, the angular velocity sensor 105 and acceleration sensor 106 may be configured to detect angular velocity and acceleration about two axes.

The temperature detected by the temperature sensor 110 may also be used to correct the temperature at the focus position of the imaging lens 109 and the temperature of the output of the image sensor 102.

The gimbal 200 is configured as a gimbal mechanism that supports the imaging unit 100 rotatably about the roll axis, pitch axis, and yaw axis relative to a base unit 204. The gimbal 200 has a pitch-axis drive mechanism 201, a yaw-axis drive mechanism 202, and a roll-axis drive mechanism 203, and the imaging unit 100 can be rotated about the roll axis, pitch axis, and yaw axis by the actuators in these drive mechanisms 201 to 203.

The orientation control unit 104 within the imaging unit 100 controls the drive mechanisms 201 to 203 based on the angular velocity and acceleration obtained through the angular velocity sensor 105 and acceleration sensor 106. There are three gimbal modes as the control method for the orientation control unit 104.

The first is a fixed mode for controlling the drive mechanisms 201 to 203 to maintain the orientation of the imaging unit 100 around all axes regardless of changes in the orientation of the base unit 204, thereby reducing shake.

The second is a follow mode for controlling the drive mechanisms 201 to 203 so that the changes in the orientation of the imaging unit 100 follow changes in the orientation of the base unit 204, i.e., the base unit 204 and imaging unit 100 change orientation together. In the follow mode, the orientation of the imaging unit 100 can be made to follow the orientation of the base unit 204 around all axes, including the roll axis, pitch axis, and yaw axis, or it can be maintained around one or two axes and made to follow the orientation of the base unit 204 around the remaining axes.

The third is encoder control mode for controlling each drive mechanism 201 to 203 around all axes based on the drive angles of the drive mechanisms 201 to 203 detected by an encoder described below. The encoder control mode uses the drive angles of each drive mechanism 201 to 203 detected by an encoder 403 and controls the drive angles of the drive mechanisms 201 to 203 so that they match the target angles. The encoder control mode does not depend on information from an angular velocity sensor (gyro) or an acceleration sensor, and is therefore not affected by the angular velocity offset described below.

The imaging control unit 101, lens control unit 107, and orientation control unit 104 may be configured using separate processors (computers) such as CPUs or MPUs, or may be configured using a single processor.

The grip portion 300 is a portion that is held by the hand of a user holding the image pickup apparatus for imaging, and is fixed to the base unit 204. The grip portion 300 includes a display unit (notification unit) 301 and an operation unit 302.

The operation unit 302 includes a power button for switching the power on and off, an imaging button for instructing imaging, and a mode button for instructing switching between imaging modes (still image/moving image modes).

The display unit 301 displays image data generated by imaging and displays menus for various settings. The display unit 301 may have a touch sensor for detecting various touch operations.

While this embodiment discusses an image pickup apparatus in which the imaging unit 100 and gimbal 200 are integrated, the imaging unit may be attachable to and detachable from the gimbal 200. In this case, the orientation control unit 104, angular velocity sensor 105, acceleration sensor 106, and temperature sensor 110 may be provided on the gimbal 200.

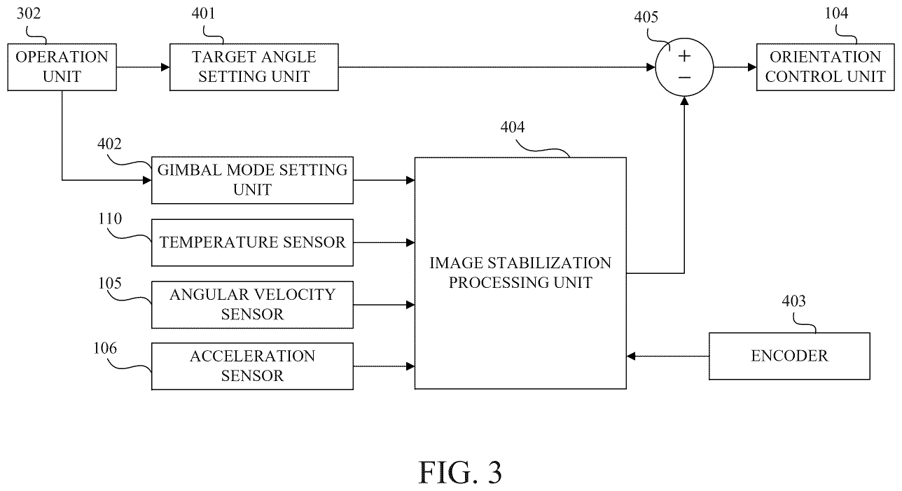

FIG. 3 illustrates the configuration of the orientation control circuit of the imaging unit 100. This orientation control circuit includes an operation unit 302, a target angle setting unit 401, a gimbal mode setting unit 402, an encoder 403, an image stabilization processing unit 404, an adder 405, the orientation control unit 104, an angular velocity sensor 105, an acceleration sensor 106, and a temperature sensor 110. The target angle setting unit 401, the gimbal mode setting unit 402, the image stabilization processing unit 404, and the adder 405 are configured by one or more processors. The target angle setting unit 401, the gimbal mode setting unit 402, the image stabilization processing unit 404, and the adder 405 may be provided within the orientation control unit 104.

The target angle setting unit 401 sets the target angle of the gimbal 200 according to the operation of the operation unit 302. The gimbal mode setting unit 402 sets the gimbal mode selected by the operation of the operation unit 302. The encoder 403 detects the drive angles of each of the drive mechanisms 201 to 203.

The image stabilization processing unit 404 calculates an image stabilizing amount, which is the drive amounts of the drive mechanisms 201 to 203, so that the angular velocity of the imaging unit 100 detected via the angular velocity sensor 105 approaches zero. The calculation of the image stabilizing amount uses information on the angular velocity, acceleration, drive angle, and temperature detected by each of the angular velocity sensor 105, acceleration sensor 106, encoder 403, and temperature sensor 110.

The adder 405 adds the target angle and the image stabilizing amount and outputs the addition result to the orientation control unit 104. The orientation control unit 104 controls the drive mechanisms 201 to 203 based on the addition result. The image stabilization processing unit 404 and the orientation control unit 104 constitute a control unit (control apparatus). More specifically, the control apparatus includes one or more memories (such as the memory 103) storing instructions, and one or more processors (such as the orientation control unit 104 and the image stabilization processing unit 404) that, upon execution of the instructions, operate to control the gimbal 200 (support unit) using a control method (control manner) selected from a plurality of control methods (control manners).

As described above, the output of the angular velocity sensor includes an angular velocity component (referred to as an angular velocity offset hereinafter) equivalent to an offset value (offset error), and the angular velocity offset varies according to the temperature. Thus, in this embodiment as well, the angular velocity offset for each temperature of the angular velocity sensor 105 is acquired (estimated) and calibration is performed to update the angular velocity offset in the angular velocity-temperature correction table, which will be described later.

Adding or subtracting the angular velocity offset corresponding to the temperature of the angular velocity sensor 105 from the angular velocity obtained through the angular velocity sensor can detect an accurate angular velocity regardless of the temperature. Then, this embodiment determines whether to perform calibration and prompts (recommends) the user to perform calibration only when it is determined to be necessary, thereby reducing the frequency of calibration.

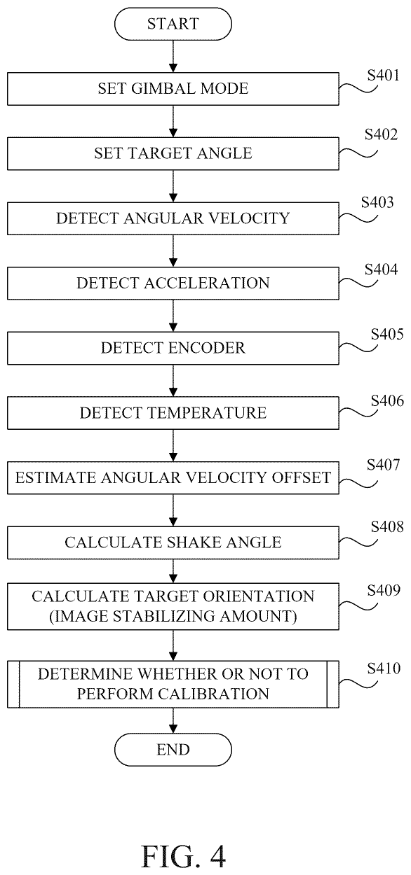

A flowchart in FIG. 4 illustrates the processing (control method) up to the determination of whether calibration of the angular velocity sensor 105 is to be performed in this embodiment. The image stabilization processing unit 404 executes this processing in accordance with a program.

In step S401, the gimbal mode setting unit 402 sets the gimbal mode according to the operation of the operation unit 302, and in step S402, the target angle setting unit 401 sets the target angle for each of the drive mechanisms 201 to 203 according to the operation of the operation unit 302. Thereafter, the image stabilization processing unit 404 performs the processing of step S403.

In step S403, the image stabilization processing unit 404 detects the angular velocity of the imaging unit 100 via the angular velocity sensor 105.

Next, in step S404, the image stabilization processing unit 404 detects the acceleration of the imaging unit 100 via the acceleration sensor 106.

Next, in step S405, the image stabilization processing unit 404 detects the drive angles of each of the drive mechanisms 201 to 203 via the encoder 403.

Next, in step S406, the image stabilization processing unit 404 detects the temperature of the imaging unit 100, that is, the angular velocity sensor 105, using the temperature sensor 110.

Next, in step S407, the image stabilization processing unit 404 estimates (acquires) the angular velocity offset of the angular velocity sensor 105 based on the temperature of the angular velocity sensor 105 detected in step S406 (referred to as detected temperature hereinafter) and the angular velocity-temperature correction table stored in the memory 103. The angular velocity-temperature correction table is correction data related to the angular velocity offset for each temperature.

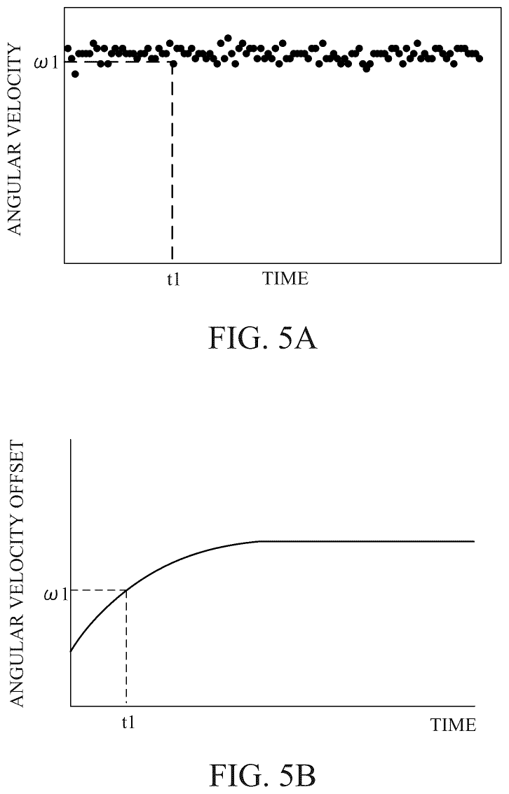

FIG. 5A illustrates the change in angular velocity over time in a case where the image pickup apparatus is disposed on a flat surface in a completely stationary state and the angular velocity is detected through the angular velocity sensor 105 at a certain constant period. In FIG. 5A, angular velocity ω1 is detected at time t1, and fluctuates relative to the angular velocity ω1 at other times. Thus, the angular velocity detected through the angular velocity sensor 105 fluctuates due to the angular velocity offset even in the completely stationary state.

FIG. 5B illustrates the change in angular velocity offset over time in a case where the image pickup apparatus is disposed on a flat surface in a completely stationary state and the imaging unit 100 captures an image for a long period of time. In a case where the imaging unit 100 captures an image for a long period of time, the temperature of the imaging unit 100 rises due to heat generated by heating elements such as the image sensor 102 and imaging control unit 101. This temperature rise causes the angular velocity offset to change (increase).

FIG. 5C illustrates the angular velocity-temperature correction table described above. The angular velocity-temperature correction table is updated by performing calibration. It is stored in the memory 103 as the latest angular velocity-temperature correction table.

The image stabilization processing unit 404 obtains the angular velocity offset corresponding to the detected temperature in the angular velocity-temperature correction table. In a case where the angular velocity-temperature correction table has an angular velocity offset corresponding to the temperature detected by the temperature sensor 110, that angular velocity offset is read. In a case where the angular velocity-temperature correction table does not have an angular velocity offset corresponding to the detected temperature, the angular velocity offset corresponding to the detected temperature is calculated using interpolation processing such as linear interpolation.

For example, in the angular velocity-temperature correction table, let ωa and ωb be angular velocity offsets corresponding to temperatures Ta and Tb, respectively, and let Tx be temperature detected by the temperature sensor 110. Then, the angular velocity offset ωx corresponding to the detected temperature Tx can be obtained by the following equation (1):

ωx=(ωb−ωa)/(Tb−Ta)×(Tx−Ta)+ωa (1)

Next, in step S408, the image stabilization processing unit 404 calculates a shake angle of the imaging unit 100. The method for calculating the shake angle differs for a encoder control mode, follow mode, and fixed mode in the gimbal mode. The image stabilization processing unit 404 calculates the image stabilizing amount required to bring the calculated shake angle closer to zero in step S409.

In encoder control mode, the shake angle is calculated using only the drive angle detected via the encoder 403.

In follow mode, the shake angle is calculated based on the angular velocity detected by the angular velocity sensor 105 and the drive angle detected by the encoder 403. More specifically, when the base unit 204 moves around any of the pitch, yaw, or roll axes, the shake angle required to maintain constant a positional relationship between the base unit 204 and the imaging unit 100 is calculated from the angular velocity and drive angle detected by the angular velocity sensor 105 and encoder 403.

In the fixed mode, the shake angle is calculated using the angular velocity and acceleration detected by the angular velocity sensor 105 and acceleration sensor 106.

In general, angular velocity sensors have high accuracy in detecting angular velocity for high-frequency shake, but low accuracy in detecting angular velocity for low-frequency shake due to the influence of the angular velocity offset. The acceleration sensor 106 has high accuracy in detecting acceleration for low-frequency movement, but low accuracy in detecting acceleration for high-frequency movement. To improve the shake detection accuracy, in the fixed mode, the shake angle θ is detected complementarily using both the angular velocity and acceleration detected by the angular velocity sensor 105 and acceleration sensor 106, as expressed in the following equation (2):

θ(t)=(1−α)×[θ(t−1)+ω·Δt]+α·θ_{accel} (2)

In equation (2), θ(t) is the shake angle θ at time t. α is a filter coefficient set between 0 and 1. The closer this coefficient is to 1, the higher the detection accuracy for high-frequency shake. ω is an angular velocity detected by the angular velocity sensor 105. Δt is a time interval for calculating the shake angle. θ_{accel} is the acceleration detected by the acceleration sensor 106.

Calculating the shake angle using both the angular velocity and the acceleration in this way can improve the calculation accuracy of the shake angle when low-frequency shake occurs, which reduces the detection accuracy of the angular velocity sensor 105. Even if the angular velocity sensor 105 has an angular velocity offset, the influence of the angular velocity offset can be reduced by compensating for the shake angle in the low-frequency range using the acceleration.

However, the influence of the angular velocity offset can only be reduced for the angular velocity around the pitch axis extending in the x direction and the angular velocity around the roll axis extending in the y direction, in a case where the z direction in which the yaw axis extends is set to the gravity direction, as illustrated in FIG. 1A. Since the direction of the angular velocity around the yaw axis extending in the z direction is orthogonal to the gravity direction, compensation by acceleration around the yaw axis is ineffective when capturing an image in the orientation illustrated in FIG. 1A, and the influence of the angular velocity offset cannot be reduced. This applies not only when the image pickup apparatus is oriented as illustrated in FIG. 1A, but also when the direction in which the yaw axis extends is closer to the gravity direction than the directions in which the pitch and roll axes extend, as illustrated in FIG. 1B.

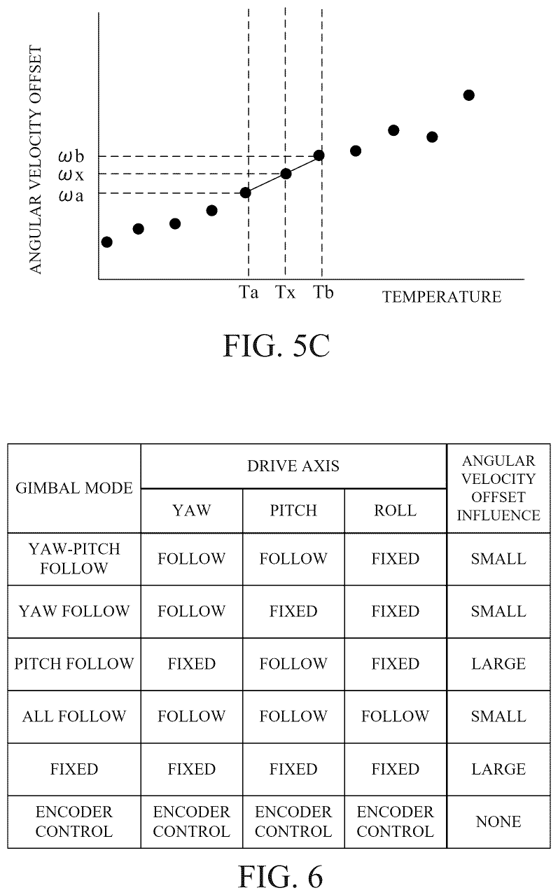

FIG. 6 illustrates the influence of the angular velocity offset for each gimbal mode. The yaw-pitch follow mode is a follow mode in which the orientation of the imaging unit 100 follows the orientation of the base unit 204 around the yaw axis and the pitch axis, and maintains the orientation of the imaging unit 100 around the roll axis. The yaw follow mode is a follow mode in which the orientation of the imaging unit 100 follows the orientation of the base unit 204 around the yaw axis, and maintains the orientation of the imaging unit 100 around the pitch axis and the roll axis. The pitch follow mode is a follow mode in which the orientation of the imaging unit 100 follows the orientation of the base unit 204 around the pitch axis, and maintains the orientation of the imaging unit 100 around the yaw axis and the roll axis. The all follow mode is a follow mode in which the orientation of the imaging unit 100 follows the orientation of the base unit 204 around all axes. The fixed mode and encoder control mode are as described above.

The fixed mode, yaw-pitch follow mode, yaw follow mode, and pitch follow mode correspond to an angular velocity using method in which the gimbal 200 is controlled using the angular velocity detected through the angular velocity sensor 105. The all follow mode and encoder control mode correspond to an angular velocity non-using method in which the angular velocity detected through the angular velocity sensor 105 is not used. Among the angular velocity using method, the pitch follow mode and fixed mode correspond to a first method that uses the angular velocity around the yaw axis (first axis) as a specific axis. Each of the yaw-pitch follow mode and yaw follow mode corresponds to a second method that uses the acceleration around at least one of the pitch axis and roll axis (second axis) as a specific axis.

As understood from FIG. 6, the influence of the angular velocity offset is greatest in the pitch follow mode and fixed mode, in which the angular velocity around the yaw axis detected through the angular velocity sensor 105 is used to control the yaw-axis drive mechanism 202. On the other hand, the influence of the angular velocity offset is small in the yaw-pitch follow mode, the yaw follow mode, the pitch follow mode, and all follow mode, in which the angular velocity around the yaw axis detected by the angular velocity sensor is not used to control the yaw-axis drive mechanism 202. Since the angular velocity detected by the angular velocity sensor 105 is not used in the encoder control mode, there is no influence of the angular velocity offset.

Next, in step S409, the image stabilization processing unit 404 calculates a target orientation by adding the target angle set in step S402 and the shake angle calculated in step S408, and calculates the image stabilizing amount of each drive mechanism required to achieve the target orientation.

Next, in step S410, the image stabilization processing unit 404 determines whether calibration is to be performed. This flow then ends.

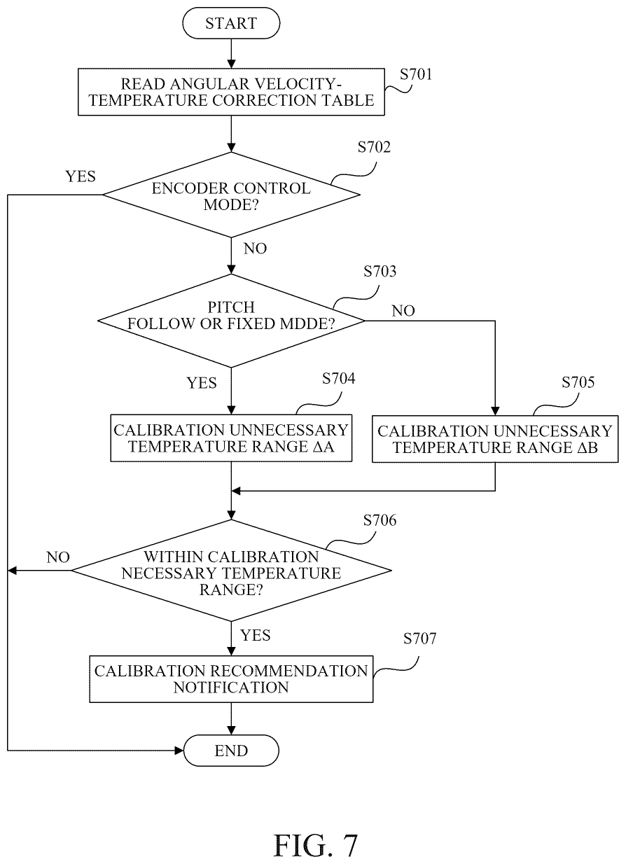

A flowchart in FIG. 7 illustrates the processing for determining whether calibration is to be performed, which is performed in step S410.

In step S701, the image stabilization processing unit 404 reads the angular velocity-temperature correction table stored in memory 103.

Next, in step S702, the image stabilization processing unit 404 determines whether the gimbal mode is the encoder control mode. In a case where the gimbal mode is the encoder control mode, this processing ends; in a case where the gimbal mode is not the encoder control mode, the flow proceeds to step S703.

In step S703, the image stabilization processing unit 404 determines whether the gimbal mode is the pitch follow mode or the fixed mode. In a case where the gimbal mode is neither the pitch follow mode nor the fixed mode (in a case where the gimbal mode is either the yaw-pitch follow mode, the yaw follow mode, the pitch follow mode, or the all follow mode), the flow proceeds to step S705. In a case where the gimbal mode is the pitch follow mode or the fixed mode, the flow proceeds to step S704.

In step S704, the image stabilization processing unit 404 sets a calibration unnecessary temperature range ΔA as a predetermined range in which calibration is not required. In step S705, the image stabilization processing unit 404 sets a calibration unnecessary temperature range ΔB.

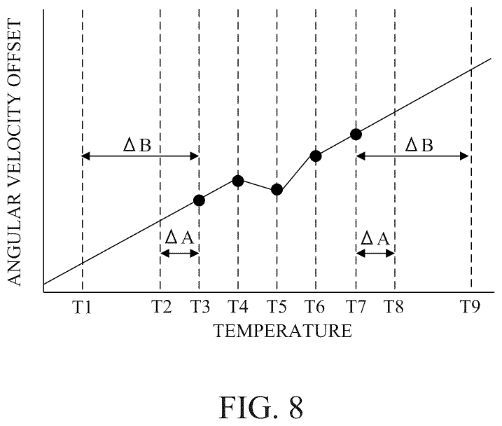

The calibration unnecessary temperature range will now be discussed with reference to FIG. 8. FIG. 8 illustrates the angular velocity-temperature correction table with the calibration unnecessary temperature ranges ΔA and ΔB added. Each black dot in FIG. 8 indicates the angular velocity offset values obtained by previous calibrations for each temperature. Here, a temperature T5 is assumed to be the temperature that is most frequently used, and provides a more highly accurate angular velocity offset than the calibrated temperature range T3 to T7. The calibration unnecessary temperature ranges ΔA and ΔB are set at the upper and lower limits of the calibrated temperature range.

The calibration unnecessary temperature range ΔA is between T3 and T2, which is lower than T3 by ΔA, and between T7 and T8, which is higher than T7 by ΔA. The calibration is required at temperatures lower than T2 and higher than T8. In a case where the temperature detected by the angular velocity sensor 105 is within the calibration unnecessary temperature range ΔA, calibration is unnecessary.

The calibration unnecessary temperature range ΔB is between T3 and T1, which is lower than T3 by ΔB, and between T7 and T9, which is higher than T7 by ΔB. The calibration is required at temperatures lower than T1 and higher than T9. In a case where the temperature detected by the angular velocity sensor 105 is within the calibration unnecessary temperature range ΔB, calibration is unnecessary.

The calibration unnecessary temperature range is set in order to distinguish between a temperature range in which calibration is not necessary and a temperature range in which calibration is necessary, and therefore setting the calibration unnecessary temperature range is equivalent to setting the calibration necessary temperature range. For example, instead of setting the calibration unnecessary temperature range ΔA between T2 and T3, a calibration unnecessary temperature range ΔA′ may be set at a temperature lower than T2.

Thus, this embodiment changes the calibration unnecessary temperature range according to the gimbal mode (whether it is the first method or the second method). In other words, this embodiment changes the calibration necessary temperature range according to the gimbal mode (whether it is the first method or the second method). More specifically, in the pitch follow and fixed modes, calibration is required at temperatures closer to the calibrated temperature range than in other modes.

Since calibration has already been completed for the calibrated temperature range T3 to T7, in a case where the detected temperature of the angular velocity sensor 105 is within this range, new calibration may or may not be performed. In a case where new calibration is performed within the calibrated temperature range, the temperature range that excludes the calibration unnecessary temperature range (second temperature range) ΔA or ΔB from the calibrated temperature range (first temperature range) may be set to the calibration necessary temperature range as the predetermined range.

The calibration unnecessary temperature ranges on the upper limit side and lower limit side of the calibrated temperature range may be different from each other. A calibration unnecessary temperature range may be set on only one of the upper limit side and lower limit side of the calibrated temperature range. For example, in a case where an angular velocity sensor is used that has a characteristic that a change amount in angular velocity offset increases as the temperature increases, the calibration unnecessary temperature range on the upper limit side of the calibrated temperature range may not be provided or may be narrower than that on the lower limit side.

After steps S704 and S705, in step S706, the image stabilization processing unit 404 determines whether the temperature detected by the temperature sensor 110 is within the calibration necessary temperature range (a predetermined range). In a case where the detected temperature is outside the usable temperature range, the processing of step S707 is performed, and in a case where it is within the usable temperature range, calibration is considered unnecessary and this flow ends.

In step S707, the image stabilization processing unit 404 instructs the imaging control unit 101 to issue a calibration recommendation notification. The imaging control unit 101, upon receiving this instruction, causes the display unit 301 to display a message as a calibration recommendation notification, prompting the user to perform calibration. The message may also be output as audio from a speaker serving as notification unit.

A user who has received this message can perform a new calibration by following the procedure displayed on the display unit 301. In other words, the user may perform calibration every time a calibration recommendation notification message is displayed. This reduces the calibration frequency.

While this embodiment has discussed the determination of whether or not calibration is to be performed in the image pickup apparatus having the imaging unit as the supported object, a similar determination of whether calibration is to be performed may be made in various apparatuses having supported objects other than the imaging unit.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can reduce the calibration frequency of correction data on an angular velocity sensor.

This application claims the benefit of Japanese Patent Application No. 2025-030862, filed on Feb. 28, 2025, and which is hereby incorporated by reference herein in its entirety.

What is claimed is:

1. An apparatus comprising:
a supported object;
a support unit configured to rotate the supported object around a plurality of axes;
an angular velocity sensor configured to detect an angular velocity of the supported object around the plurality of axes;
a temperature sensor configured to detect a temperature of the angular velocity sensor;
one or more memories storing instructions; and
one or more processors that, upon execution of the instructions, operate to control the support unit using a control method selected from a plurality of control methods,
wherein the plurality of control methods include, as an angular velocity using method for controlling the support unit using the angular velocity around a specific axis among the plurality of axes and correction data on an offset value of the angular velocity sensor according to the temperature, a first method in which the specific axis is a first axis, and a second method in which the specific axis is different from the first axis, and
wherein the one or more processors operate to:
issue a notification that prompts calibration to update the correction data in a case where the temperature is within a predetermined range, and
change the predetermined range according to whether the first method or the second method is selected.

2. The apparatus according to claim 1, wherein the first method is a control method for controlling the support unit so that the angular velocity around at least the first axis approaches zero, and
wherein the second method is a control method for controlling the support unit so that the angular velocity around an axis different from the first axis approaches zero.

3. The apparatus according to claim 1, wherein in a case where an orientation of the apparatus is such that a direction in which the first axis extends is closer to a gravity direction than a direction in which an axis different from the first axis extends, the one or more processors operate to make the predetermined range in the first method wider than the predetermined range in the second method.

4. The apparatus according to claim 1, wherein the one or more processors operate to set the predetermined range to at least one of an upper limit side and a lower limit side of the temperature range in which the offset value was obtained by the calibration that has already been performed.

5. The apparatus according to claim 1, wherein the one or more processors operate to:
set the predetermined range to include a first temperature range in which the offset value was obtained by the calibration that has already been performed and a range excluding a second temperature range set to at least one of an upper limit side and a lower limit side of the first temperature range, and
change the second temperature range according to whether the first method is selected or the second method is selected.

6. The apparatus according to claim 1, wherein the plurality of control methods include an angular velocity using method including the first method and the second method, and an angular velocity non-using method for controlling the support unit without using the angular velocity, and
wherein the one or more processors operate not to issue a notification that prompts the calibration in a case where the angular velocity non-using method is selected, and to issue a notification that prompts the calibration in a case where the angular velocity using method is selected and the temperature is within the predetermined range.

7. The apparatus according to claim 1, further comprising a notification unit configured to display the notification or output the notification by voice.

8. The apparatus according to claim 1, wherein the supported object is an imaging unit including an image sensor.

9. An apparatus comprising:
a supported object;
a support unit configured to rotate the supported object around a plurality of axes;
an angular velocity sensor configured to detect an angular velocity of the supported object around the plurality of axes;
a temperature sensor configured to detect a temperature of the angular velocity sensor;
one or more memories storing instructions; and
one or more processors that, upon execution of the instructions, operate to control the support unit using a control method selected from a plurality of control methods,
wherein the plurality of control methods include an angular velocity using method for controlling the support unit using the angular velocity and correction data on an offset value of the angular velocity sensor according to the temperature, and an angular velocity non-using method for controlling the support unit without using the angular velocity, and
wherein the one or more processors operate not to issue a notification that prompts calibration to update the correction data in a case where the angular velocity non-using method is selected, and operate to issue a notification that prompts the calibration in a case where the angular velocity using method is selected and the temperature is within a predetermined range.

10. A control method for an apparatus that includes a supported object, a support unit configured to rotate the supported object around a plurality of axes, an angular velocity sensor configured to detect an angular velocity of the supported object around the plurality of axes, and a temperature sensor configured to detect a temperature of the angular velocity sensor, the control method controlling the support unit using a control manner selected from a plurality of control manners that include, as an angular velocity using method for controlling the support unit using the angular velocity around a specific axis among the plurality of axes and correction data on an offset value of the angular velocity sensor according to the temperature, a first manner in which the specific axis is a first axis, and a second manner in which the specific axis is different from the first axis, the control method comprising:
issuing a notification that prompts calibration to update the correction data in a case where the temperature is within a predetermined range, and
changing the predetermined range according to whether the first method or the second method is selected.

11. A control method for an apparatus that includes a supported object, a support unit configured to rotate the supported object around a plurality of axes, an angular velocity sensor configured to detect an angular velocity of the supported object around the plurality of axes, and a temperature sensor configured to detect a temperature of the angular velocity sensor, the control method controlling the support unit using a control manner selected from a plurality of control manners that include an angular velocity using method for controlling the support unit using the angular velocity and correction data on an offset value of the angular velocity sensor according to the temperature, and an angular velocity non-using method for controlling the support unit without using the angular velocity, the control method comprising:
not issuing a notification that prompts calibration to update the correction data in a case where the angular velocity non-using method is selected; and
issuing a notification that prompts the calibration in a case where the angular velocity using method is selected and the temperature is within a predetermined range.

12. A non-transitory computer-readable storage medium storing a program that causes a computer to execute the control method recited in claim 10.

13. A non-transitory computer-readable storage medium storing a program that causes a computer to execute the control method recited in claim 11.
